(19) United States
(12) Patent Application Publication
(10) Pub. No.: US 2025/0160391 A1
(43) Pub. Date: May 22, 2025

(54) AEROSOL-GENERATING ARTICLE WITH HEAT-SHRINKABLE WRAPPER

(71) Applicant: Philip Morris Products S.A., Neuchatel (CH)

(72) Inventors: Clement BESSO, Neuchatel (CH); Attila LUKACS, Fontaines (CH)

(73) Assignee: Philip Morris Products S.A., Neuchatel (CH)

(21) Appl. No.: 18/840,526

(22) PCT Filed: Feb. 21, 2023
(86) PCT No.: PCT/EP2023/054276

§ 371 Date: Aug. 22, 2024

(30) Foreign Application Priority Data
Mar. 1, 2022 (EP) 22159501.0

(51) Int. Cl. A24D 1/02; A24B 15/167; A24D 1/20; A24F 40/20; A24F 40/465; H05B 6/10

(52) U.S. Cl. CPC A24D 1/02; A24B 15/167; A24D 1/20; A24F 40/20; A24F 40/465; H05B 6/108

(57) ABSTRACT

An aerosol-generating article is provided, including: an aerosol-forming substrate portion; and a heat-shrinkable wrapper at least partly circumscribing the aerosol-forming substrate portion, the heat-shrinkable wrapper having a shrinkage rate in length of 1% to 25% at a temperature of 120 degrees Celsius or below, and the aerosol-generating article being configured as a heat-not-burn article for use with an aerosol-generating device. An aerosol-generating system including the aerosol-generating article is also provided.

The present disclosure relates to an aerosol-generating article. The present disclosure further relates to an aerosol-generating system.

It is known to provide an aerosol-generating device for generating an inhalable vapor. Such devices may heat an aerosol-forming substrate contained in an aerosol-generating article without burning the aerosol-forming substrate. The aerosol-generating article may have a rod shape for insertion of the aerosol-generating article into a heating chamber of the aerosol-generating device.

The aerosol-generating device may comprise a heating arrangement. The heating arrangement may be an induction heating arrangement and may comprise an induction coil configured to inductively heat a susceptor. The susceptor may be part of the device or may be part of the aerosol-generating article.

Upon heating of an aerosol-generating article, a certain degree of structural rearrangement of the aerosol-forming substrate in the article may take place. This may be due to thermal processes, for example a reduction in volume due to successive volatilization of volatile components of the aerosol-forming substrate. This may result in a reduction of the thermal contact between the aerosol-forming substrate and the heating element during use. This may result in an alteration of the resistance to draw during use.

It would be desirable to provide an aerosol-generating article with an improved heating performance. It would be desirable to provide an aerosol-generating article with an improved thermal contact to the heating element during use. It would be desirable to provide an aerosol-generating article with an improved control of resistance to draw. It would be desirable to provide an aerosol-generating article with a more constant resistance to draw during use.

It would be desirable to provide an aerosol-generating article which allows an improved extraction of the used aerosol-generating article from a heating chamber of an aerosol-generating device.

It would be desirable to provide an aerosol-generating article which allows for a user to visually detect whether the article is a fresh article or a used article.

It would be desirable to provide an aerosol-generating article with reduced staining.

According to an embodiment of the invention there is provided an aerosol-generating article comprising a heat-shrinkable wrapper. The aerosol-generating article may comprise an aerosol-forming substrate portion and the heat-shrinkable wrapper may at least partly circumscribe the aerosol-forming substrate portion.

According to an embodiment of the invention there is provided an aerosol-generating article, comprising an aerosol-forming substrate portion and a heat-shrinkable wrapper at least partly circumscribing the aerosol-forming substrate portion.

During use of the aerosol-generating article, the aerosol-forming substrate is heated to volatilize compounds of the aerosol-forming substrate. The heat-shrinkable wrapper circumscribing the aerosol-forming substrate portion may thereby also be heated, for example by means of heat transfer from the aerosol-forming substrate. Upon being heated, the heat-shrinkable wrapper may contract or shrink in an area where the heat-shrinkable wrapper circumscribes the aerosol-forming substrate. The contraction of the heat-shrinkable wrapper may result in a reduction of the outer diameter of the aerosol-generating article during use in that area.

A user may visually verify whether an aerosol-generating article comprises at least a part with a reduced diameter. An aerosol-generating article which allows for a user to visually detect whether it is a fresh article or a used article may be provided.

For heating the aerosol-forming substrate portion, for example, at least a part of the aerosol-generating article comprising the aerosol-forming substrate portion may be inserted into a heating chamber of an aerosol-generating device. Contraction of the heat-shrinkable wrapper during heating may result in a reduction of the outer circumference of the aerosol-generating article. In other words, the diameter of the aerosol-generating article may be reduced. This may provide for an improved extractability of the aerosol-generating article out of the heating chamber after use.

During heating, volatile compounds of the aerosol-forming substrate may be volatized. Thereby, the mass and density of the aerosol-forming substrate may reduce during heating. A reduced density may result in a reduced retention to draw. The contraction of the heat-shrinkable wrapper may compress the heated aerosol-forming substrate. Thereby, a reduction in density may be counteracted. A reduction in retention to draw may be counteracted. An aerosol-generating article with an improved control of the resistance to draw may be provided. An aerosol-generating article with a more constant resistance to draw during use may be provided.

Contraction of the heat-shrinkable wrapper during heating may result in a compaction or compression of the aerosol-forming substrate portion. An improved nicotine delivery may be provided. An improved structural stability of the compacted aerosol-forming substrate portion may be provided. An improved thermal conductivity of the compacted aerosol-forming substrate portion may be improved. Thereby, effectiveness of heating may be improved.

The aerosol-generating article may be configured as a heat-not-burn article. The heat-not-burn article may be configured to be used with an aerosol-generating device.

The aerosol-generating article may comprise a susceptor element. The susceptor element may be arranged to be inductively heated by an inductor coil of an aerosol-generating device.

The susceptor element may be circumscribed by the aerosol-forming substrate portion. The susceptor element may be arranged centrally within the aerosol-forming substrate portion.

Contraction of the heat-shrinkable wrapper during heating may result in a compaction or compression of the aerosol-forming substrate portion towards the susceptor element. An improved thermal contact between the susceptor element and the aerosol-forming substrate portion may be provided. Thereby, effectiveness of heating may be improved.

During use, the aerosol-forming substrate portion comprising the susceptor element may be heated by an inductor coil of an aerosol-generating device. At least a portion of the heat-shrinkable wrapper circumscribing the aerosol-forming substrate portion may also heat up and shrink. Shrinking of the heat-shrinkable wrapper may result in the contracted wrapper pressing the aerosol-forming substrate towards the centrally arranged susceptor. The thermal contact between the susceptor element and the aerosol-forming substrate may be improved. Heating efficiency may be improved.

The heat-shrinkable wrapper may at least partly circumscribe one or more anchoring elements. The anchoring element may be one or both of a filter element, a hollow tubular element, and a front plug.

The anchoring element may provide additional structural stability to the aerosol-generating article comprising the heat-shrinkable wrapper. When exposed to heat, the heat-shrinkable wrapper may shrink in an area which circumscribes the aerosol-forming substrate portion. Another area of the heat-shrinkable wrapper may circumscribe the anchoring element. This other area of the heat-shrinkable wrapper may not shrink, or may shrink only little, during use. For example, the material of the anchoring element may be rigid enough to hinder the heat-shrinkable wrapper from substantially shrinking in that area. For example, the heat-shrinkable wrapper may be not heated, or may be hardly heated, in the area of the anchoring element because the anchoring element may not be significantly heated during use. Thereby, in the area where the heat-shrinkable wrapper is anchored to the anchoring element, there may be only little structural changes during use. A durable anchoring of the heat-shrinkable wrapper may be provided. An improved structural stability of the aerosol-generating article may be provided.

The aerosol-generating article may be at least partly inserted into a cavity of an aerosol-generating device during use. An outer diameter of the aerosol-generating article and an inner diameter of the cavity may be about the same, or may be similar. The aerosol-generating article may be held by a frictional fit within the cavity. At the position of the anchoring element, the diameter of the aerosol-generating article may not shrink, or may shrink only little, during use. The anchoring element may thus assist in maintaining a frictional fit of the aerosol-generating article within the cavity during use. At least a part of the cavity may be configured as a heating chamber of the aerosol-generating device.

The aerosol-generating article may comprise a front plug arranged at a distal end of the aerosol-generating article. The front plug may comprise a filter material. The heat-shrinkable wrapper may at least partly circumscribe the front plug. The front plug may be arranged as an anchoring element.

The length of the front plug may be 4 millimeters or greater, preferably 5 millimeters or greater, more preferably 6 millimeters or greater. The length of the front plug may be measured along a longitudinal direction of the aerosol-generating article.

Having a front plug with, for example a length of 4 millimeters or more, may improve the anchoring effectiveness of the front plug in comparison to shorter front plugs. The greater lengths may allow for a greater portion of the heat-shrinkable wrapper to circumscribe the anchoring element and to thus be structurally supported by the anchoring element.

The ratio of a length of the front plug to a length of the aerosol-forming substrate portion may be 0.3 or greater, preferably 0.4 or greater, more preferably 0.5 or greater. The length of the front plug and the length of the aerosol-forming substrate portion may be measured along a longitudinal direction of the aerosol-generating article.

The length of the aerosol-forming substrate portion may be between 7 millimeters and 17 millimeters, preferably between 9 millimeters and 15 millimeters, more preferably between 11 millimeters and 13 millimeters, more preferably about 12 millimeters.

A total length of aerosol-generating article may be between 40 millimeters and 50 millimeters, preferably about 45 millimeters. A length of the aerosol-forming substrate portion along a longitudinal direction of the aerosol-generating article may be between 20% and 35% of the total length of the aerosol-generating article, between 24% and 30% of the total length of the aerosol-generating article, more preferably about 27% of the total length of the aerosol-generating article.

The density of the aerosol-forming substrate portion may be between 0.3 gram per cubic centimeter and 1 gram per cubic centimeter, preferably between 0.4 gram per cubic centimeter and 0.9 gram per cubic centimeter. At lower densities of the aerosol-forming substrate portion, for example below 0.3 gram per cubic centimeter, the aerosol-forming substrate portion may be too easily compressible such that the aerosol-generating article may shrink more than is intended. At higher densities of the aerosol-forming substrate portion, for example above 1 gram per cubic centimeter, the aerosol-forming substrate portion may be hardly compressible such that the aerosol-generating article may be hindered from substantially shrinking during use.

The aerosol-generating substrate portion may have a density of 0.5 gram per cubic centimeter or less. The aerosol-generating substrate portion may have a density of between 0.24 gram per cubic centimeter and 0.45 gram per cubic centimeter. The aerosol-generating substrate portion may have a density of between 0.24 gram per cubic centimeter and 0.4 gram per cubic centimeter, between 0.24 gram per cubic centimeter and 0.34 gram per cubic centimeter, between 0.24 gram per cubic centimeter and 0.3 gram per cubic centimeter, or between 0.24 gram per cubic centimeter and 0.34 gram per cubic centimeter. The aerosol-generating substrate may have a density of about 0.28 gram per cubic centimeter.

As used herein, the “density” of the aerosol-generating substrate portion refers to the mass of the aerosol-generating substrate in the aerosol-generating substrate portion divided by the volume taken up by the aerosol-generating substrate when in the aerosol-generating article. The “mass” of the aerosol-generating substrate does not include the mass of any wrapping material circumscribing the aerosol-generating substrate portion. The “volume” taken up by the aerosol-generating substrate does not include the volume of any wrapping material circumscribing the aerosol-generating substrate portion.

The aerosol-forming substrate of the aerosol-forming substrate portion may comprise an aerosol former. The aerosol former may be selected from one or more of polyhydric alcohols, esters of polyhydric alcohols, and aliphatic esters of mono-, di- or polycarboxylic acids. The aerosol former may comprise polyhydric alcohols or mixtures thereof. The aerosol former may comprise or may consist of glycerine.

The aerosol-forming substrate may comprise an aerosol former content of equal to or greater than 5 percent by weight on a dry weight basis, preferably from 5 percent to 30 percent by weight on a dry weight basis. The aerosol-forming substrate may comprise an aerosol former content of equal to or greater than 10 percent by weight on a dry weight basis, preferably from 10 percent to 30 percent by weight on a dry weight basis. The aerosol-forming substrate may comprise an aerosol former content of equal to or greater than 15 percent by weight on a dry weight basis, preferably from 15 percent to 30 percent by weight on a dry weight basis.

The aerosol-generating article may comprise one or more hollow tubular elements. The one or more hollow tubular elements may comprise one or both of a hollow acetate tube (HAT) and a fine hollow acetate tube (FHAT). Such hollow tubes are cylindrical components which are made from cellulose acetate and which are provided with centrally arranged axial holes. The dimensions of the hollow tubes such as their outer diameter or the diameter of the hole vary and can be designed according to the demands of the respective products.

As used herein, the term ‘heat-shrinkable wrapper’ refers to a wrapper made from a material that contracts under exposure of heat.

The heat-shrinkable wrapper may be a monoaxially oriented heat-shrinkable wrapper. As used herein, the term ‘monoaxially oriented heat-shrinkable wrapper’ refers to a wrapper that is heat-shrinkable in only one heat-shrinkable direction and is not substantially heat-shrinkable in an orthogonal direction. The heat-shrinkable direction may be the machine direction. The heat-shrinkable direction may be the cross-direction.

As used herein, the ‘machine direction’ is the direction of forward movement of the forming wrapper on the wrapper-making machine or papermaking machine. The direction perpendicular to this direction is called ‘cross-direction’.

The monoaxially oriented heat-shrinkable wrapper may be arranged in the aerosol-generating article, such that the heat-shrinkable direction is oriented in perpendicular to the longitudinal axis of the aerosol-generating article.

Generally, it may not be intended that a length of the aerosol-generating article shrinks to a greater extent during use. Generally, it may be intended that mainly the circumference the aerosol-generating article shrinks during use. This may be achieved by an arrangement, where the main heat-shrinkable direction of the heat-shrinkable wrapper is oriented in perpendicular to the longitudinal axis of the aerosol-generating article.

The heat-shrinkable wrapper may be a biaxially oriented heat-shrinkable wrapper. As used herein, the term ‘biaxially oriented heat-shrinkable wrapper’ refers to a wrapper that is heat-shrinkable in both a heat-shrinkable first direction and in an orthogonal heat-shrinkable second direction. The first direction may be the machine direction and the second direction may be the cross-direction. The first direction may be the cross-direction and the second direction may be the machine direction.

The biaxially oriented heat-shrinkable wrapper may have identical shrinkage rates in both the first direction and the second direction.

The biaxially oriented heat-shrinkable wrapper may have a higher shrinkage rate in the first direction than in the second direction. In that case, the heat-shrinkable wrapper may be arranged in the aerosol-generating article, such that the second direction with the lower shrinkage rate is oriented in parallel to the longitudinal axis of the aerosol-generating article.

The heat-shrinkable wrapper may have a shrinkage rate in length of 1% to 25%, preferably 2% to 20%, more preferably 3% to 15%, more preferably 4% to 15%, more preferably 5% to 15%, more preferably 6% to 15%, more preferably 7% to 15%, more preferably 8% to 15%, more preferably 9% to 15%, more preferably 10% to 17%, more preferably 10% to 16%, more preferably 10% to 15%. The shrinkage rate may be measured in percent length shrinkage according to Test Method A as defined herein.

The heat-shrinkable wrapper may have a shrinkage rate in length at a temperature of 120 degrees Celsius or below of 1% to 25%, preferably 2% to 20%, more preferably 3% to 15%, more preferably 4% to 15%, more preferably 5% to 15%, more preferably 6% to 15%, more preferably 7% to 15%, more preferably 8% to 15%, more preferably 9% to 15%, more preferably 10% to 17%, more preferably 10% to 16%, more preferably 10% to 15%. The heat-shrinkable wrapper may have a shrinkage rate in length at a temperature of 120 degrees Celsius or below of 1% to 25%, preferably 2% to 20%, more preferably 3% to 15%, more preferably 4% to 15%, more preferably 5% to 15%, more preferably 6% to 15%, more preferably 7% to 15%, more preferably 8% to 15%, more preferably 9% to 15%, more preferably 10% to 17%, more preferably 10% to 16%, more preferably 10% to 15% in one or both of machine direction and cross-direction. The shrinkage rate may be measured in percent length shrinkage according to Test Method A as defined herein.

The heat-shrinkable wrapper may have a shrinkage rate in length of 1% to 25%, preferably 2% to 20%, more preferably 3% to 15%, more preferably 4% to 15%, more preferably 5% to 15%, more preferably 6% to 15%, more preferably 7% to 15%, more preferably 8% to 15%, more preferably 9% to 15%, more preferably 10% to 17%, more preferably 10% to 16%, more preferably 10% to 15%, in one or both of machine direction and cross-direction, wherein the shrinkage rate is measured in percent length shrinkage according to Test Method A as defined herein.

The heat-shrinkable wrapper may have a shrinkage rate in area of 2% to 50%, preferably 4% to 40%, more preferably 6% to 30%, more preferably 8% to 30%, more preferably 10% to 30%, more preferably 15% to 30%, more preferably 18% to 35%, more preferably 18% to 30%. The shrinkage rate may be measured in percent area shrinkage according to Test Method A as defined herein.

The heat-shrinkable wrapper may have a shrinkage rate in area at a temperature of 120 degrees Celsius or below of 2% to 50%, preferably 4% to 40%, more preferably 6% to 30%, more preferably 8% to 30%, more preferably 10% to 30%, more preferably 15% to 30%, more preferably 18% to 35%, more preferably 18% to 30%. The shrinkage rate may be measured in percent area shrinkage according to Test Method A as defined herein.

The heat-shrinkable wrapper may have a shrinkage rate in area of 2% to 50%, preferably 4% to 40%, more preferably 6% to 30%, more preferably 8% to 30%, more preferably 10% to 30%, more preferably 15% to 30%, more preferably 18% to 35%, more preferably 18% to 30%, wherein the shrinkage rate is measured in percent area shrinkage according to Test Method A as defined herein.

The heat-shrinkable wrapper may have a shrinkage rate of 1% to 25%, preferably 2% to 20%, more preferably 3% to 15%, more preferably 10% to 15%, in one or both of machine direction and cross-direction, wherein the shrinkage rate is measured in percent shrinkage according to ASTM D 2732-03.

The heat-shrinkable wrapper may have a shrinkage rate of 1% to 25%, preferably 2% to 20%, more preferably 3% to 15%, more preferably 10% to 15%, in one or both of machine direction and cross-direction, wherein the shrinkage rate is measured in percent shrinkage according to ISO 11501:1995.

The aerosol-generating article may have a shrinkage rate of 1% to 25%, preferably 2% to 20%, more preferably 3% to 15%, more preferably 10% to 15%, wherein the shrinkage rate is measured in analogy to ISO 11501 “Determination of dimensional change on heating” with film specimens sized 5×10 cm cut from the heat-shrinkable wrapper and placed in an oven in air, for 5 minutes at 120° C., and wherein the relative decrease in length of the so treated film compared to the original film is reported as percent shrinkage.

For a given heat-shrinkable wrapper, the shrinkage rates in length in machine direction and cross-direction may be identical. For a given heat-shrinkable wrapper, the shrinkage rates in length in machine direction and cross-direction may be different.

The heat-shrinkable wrapper may have a shrinkage rate in length in machine direction that exceeds the shrinkage rate in length in cross-direction and the heat-shrinkable wrapper may be arranged in the aerosol-generating article, such that the machine direction of the heat-shrinkable wrapper is oriented in perpendicular to a longitudinal axis of the aerosol-generating article.

The heat-shrinkable wrapper may have a shrinkage rate in length in cross-direction that exceeds the shrinkage rate in length in machine direction and the heat-shrinkable wrapper may be arranged in the aerosol-generating article, such that the machine direction of the heat-shrinkable wrapper is oriented in parallel to a longitudinal axis of the aerosol-generating article.

The heat-shrinkable wrapper may comprise, or may substantially consist of, one or more of cellophane, cellulose hydrate, methylcellulose, carboxymethylcellulose, biaxial orientated poly propylene (BOPP), low density polyethylene (LDPE), and high density polyethylene (HDPE).

The heat-shrinkable wrapper may comprise a cellulose derivative, preferably one or more of cellulose hydrate, methylcellulose, and carboxymethylcellulose.

The cellulose hydrate or cellophane, may be coated with polyvinylidene chloride (PVDC). The heat-shrinkable wrapper may comprise cellulose hydrate or cellophane and may not comprise any polyvinylidene chloride (PVDC).

The heat-shrinkable wrapper may comprise or may consist of an aerosol-forming substrate. The heat-shrinkable wrapper may comprise or may consist of a solid aerosol-forming substrate. The heat-shrinkable wrapper may comprise or may consist of a solid aerosol-forming substrate film.

The aerosol-forming substrate of the heat-shrinkable wrapper may comprise nicotine, one or more cellulose based agents, one or more aerosol formers, and one or more carboxylic acids.

The aerosol-forming substrate of the heat-shrinkable wrapper may comprise a total aerosol former content on a dry weight basis of at least 30 percent by weight, more preferably at least 35 percent by weight, more preferably at least 40 percent by weight, more preferably at least 45 percent by weight, more preferably at least 50 percent by weight.

The aerosol-forming substrate of the heat-shrinkable wrapper may comprise a total carboxylic acid content on a dry weight basis of between 0.1 percent by weight and 6 percent by weight, preferably between 0.5 percent by weight and 4 percent by weight, more preferably between 1.0 percent by weight and 2.5 percent by weight, more preferably between 1.4 percent by weight and 2.0 percent by weight.

The one or more carboxylic acids of the aerosol-forming substrate of the heat-shrinkable wrapper may be selected from lactic acid, levulinic acid, acetic acid, adipic acid, benzoic acid, citric acid, fumaric acid, maleic acid, malic acid, myristic acid, oxalic acid, salicylic acid, stearic acid, succinic acid, and undecanoic acid. The one or more carboxylic acids of the aerosol-forming substrate of the heat-shrinkable wrapper may be selected from acetic acid, adipic acid, benzoic acid, citric acid, fumaric acid, maleic acid, malic acid, myristic acid, oxalic acid, salicylic acid, stearic acid, succinic acid, and undecanoic acid. The one or more carboxylic acids of the aerosol-forming substrate of the heat-shrinkable wrapper may be selected from acetic acid, benzoic acid, citric acid, fumaric acid, maleic acid, and malic acid. The one or more carboxylic acids of the aerosol-forming substrate of the heat-shrinkable wrapper may be selected from fumaric acid, maleic acid, and malic acid. The one or more carboxylic acids of the aerosol-forming substrate of the heat-shrinkable wrapper may be selected from fumaric acid and maleic acid. The one or more carboxylic acids of the aerosol-forming substrate of the heat-shrinkable wrapper may be fumaric acid.

The aerosol-forming substrate of the heat-shrinkable wrapper may comprise a total tobacco content on a dry weight basis of less than 5 percent by weight, preferably less than 4 percent by weight, more preferably less than 3 percent by weight, more preferably less than 2 percent by weight, more preferably less than 1 percent by weight The aerosol-forming substrate of the heat-shrinkable wrapper may be tobacco-free.

The aerosol-forming substrate of the heat-shrinkable wrapper may have a total cellulose based agent content on a dry weight basis of between 35 percent by weight and 55 percent by weight, preferably between 40 percent by weight and 50 percent by weight, more preferably between 43 percent by weight and 47 percent by weight.

The aerosol-forming substrate of the heat-shrinkable wrapper may comprise one or more cellulose based film-forming agents selected from carboxymethyl cellulose and hydroxypropyl methylcellulose.

The aerosol-forming substrate of the heat-shrinkable wrapper may comprise one or more cellulose based strengthening agents selected from cellulose fibers, microcrystalline cellulose and cellulose powder.

The aerosol-forming substrate of the heat-shrinkable wrapper may comprise nicotine and fumaric acid, preferably wherein a molar ratio of fumaric acid to nicotine is between 1.2 to 1 and 1.8 to 1, more preferably between 1.3 to 1 and 1.7 to 1, more preferably between 1.4 to 1 and 1.6 to 1, more preferably is about 1.5 to 1.

The heat-shrinkable materials may provide a wrapper which is may be less prone to staining in comparison to wrapper made from non-heat-shrinkable wrapping papers.

The aerosol-generating article may have a cylindrical shape. The aerosol-forming substrate portion may have a cylindrical shape.

The aerosol-generating article may comprise, in order from a proximal end to a distal end of the article, a mouth-end filter, one or more intermediate elements, an aerosol-forming substrate portion, and, optionally, a front plug. The one or more intermediate elements may comprise one or more of a HAT, a FHAT, and a PLA plug. The total length of the article may be about 45 millimeters and the length of the length of the aerosol-forming substrate portion may be about 12 millimeters. The heat-shrinkable wrapper may circumscribe the complete article or only a portion thereof.

In addition to the heat-shrinkable wrapper, the aerosol-generating article may comprise one or more non-heat shrinkable wrappers. The one or more non-heat shrinkable wrappers may circumscribe the complete aerosol-generating article including the heat shrinkable wrapper. The one or more non-heat shrinkable wrappers may circumscribe the complete aerosol-generating article and may be at least partly circumscribed by the heat shrinkable wrapper.

The heat-shrinkable wrapper may circumscribe only a portion of the aerosol-generating article, and one or more non-heat shrinkable wrappers may circumscribe at least another portion of the aerosol-generating article which is not circumscribed by the heat shrinkable wrapper.

The one or more non-heat shrinkable wrappers may be paper wrappers or non-paper wrappers. Paper wrappers may comprise cigarette papers and filter plug wraps. Non-paper wrappers may comprise sheets of homogenised tobacco materials and laminate materials comprising a plurality of layers, for example aluminium co-laminated sheet.

The aerosol-generating article may comprise two or more heat-shrinkable wrappers circumscribing different longitudinal portions of the aerosol-generating article.

According to an embodiment of the invention there is provided an aerosol-generating system comprising an aerosol-generating article as described herein and an aerosol-generating device. The aerosol-generating device may comprise a cavity configured for at least partly inserting the aerosol-generating article into the cavity. The aerosol-generating article and the cavity may be dimensioned such that the aerosol-generating article is held within the cavity by a frictional fit. The aerosol-generating article may comprise an anchoring element as disclosed herein. The anchoring element may ensure that the frictional fit is maintained during use of the aerosol-generating system, when the aerosol-generating device is operated to heat the aerosol-generating article. At least a portion of the cavity may be configured as a heating chamber.

The aerosol-generating device may comprise an inductor coil. The inductor coil may at least partly circumscribe the cavity or heating chamber. The inductor coil may be arranged to coaxially circumscribe the heating chamber. The inductor coil may be arranged to inductively heat a susceptor element. The susceptor element may be part of the aerosol-generating device. The susceptor element may be part of the aerosol-generating article. The inductor coil may be arranged to inductively heat a susceptor element of an aerosol-generating article, when the aerosol-generating article is inserted into the heating chamber.

As used herein, the term ‘aerosol-forming substrate’ relates to a substrate capable of releasing volatile compounds that can form an aerosol or a vapor. Such volatile compounds may be released by heating the aerosol-forming substrate. The aerosol-forming substrate may be in solid form or may be in liquid form. The aerosol-forming substrate may be solid or liquid or may comprise both solid and liquid components. An aerosol-forming substrate may be part of an aerosol-generating article. The terms ‘aerosol’ and ‘vapor’ are used synonymously.

The aerosol-forming substrate may comprise nicotine. The nicotine-containing aerosol-forming substrate may be a nicotine salt matrix.

The aerosol-forming substrate may comprise plant-based material. The aerosol-forming substrate may comprise tobacco. The aerosol-forming substrate may comprise a tobacco-containing material including volatile tobacco flavour compounds which are released from the aerosol-forming substrate upon heating. Alternatively, the aerosol-forming substrate may comprise a non-tobacco material. The aerosol-forming substrate may comprise homogenised plant-based material. The aerosol-forming substrate may comprise homogenised tobacco material. Homogenised tobacco material may be formed by agglomerating particulate tobacco. In a particularly preferred embodiment, the aerosol-forming substrate may comprise a gathered crimped sheet of homogenised tobacco material. As used herein, the term ‘crimped sheet’ denotes a sheet having a plurality of substantially parallel ridges or corrugations.

The aerosol-forming substrate may comprise at least one aerosol former. An aerosol-former is any suitable known compound or mixture of compounds that, in use, facilitates formation of a dense and stable aerosol and that is substantially resistant to thermal degradation at the temperature of operation of the device. Suitable aerosol formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as triethylene glycol, 1, 3-butanediol. Preferably, the aerosol former is glycerine. Where present, the homogenised tobacco material may have an aerosol former content of equal to or greater than 5 percent by weight on a dry weight basis, and preferably from 5 percent to 30 percent by weight on a dry weight basis. The aerosol-forming substrate may comprise other additives and ingredients, such as flavourants.

Preferably, the aerosol-forming substrate comprises plant material and an aerosol former. Preferably, the plant material is a plant material comprising an alkaloid, more preferably a plant material comprising nicotine, and more preferably a tobacco-containing material.

Preferably, the aerosol-forming substrate comprises at least 70 percent of plant material, more preferably at least 90 percent of plant material by weight on a dry weight basis. Preferably, the aerosol-forming substrate comprises less than 95 percent of plant material by weight on a dry weight basis, such as from 90 to 95 percent of plant material by weight on a dry weight basis.

Preferably, the aerosol-forming substrate comprises at least 5 percent of aerosol former, more preferably at least 10 percent of aerosol former by weight on a dry weight basis. Preferably, the aerosol-forming substrate comprises less than 30 percent of aerosol former by weight on a dry weight basis, such as from 5 to 30 percent of aerosol former by weight on a dry weight basis.

As used herein, the term ‘aerosol-generating article’ refers to an article comprising an aerosol-forming substrate that is capable of releasing volatile compounds that can form an aerosol. For example, an aerosol-generating article may be an article that generates an aerosol that is directly inhalable by the user drawing or puffing on a mouthpiece at a proximal or user-end of the device. An aerosol-generating article may be disposable. The aerosol-generating article may be insertable into the heating chamber of the aerosol-generating device.

As used herein, the term ‘aerosol-generating device’ refers to a device that interacts with an aerosol-forming substrate to generate an aerosol. An aerosol-generating device may interact with an aerosol-generating article comprising an aerosol-forming substrate. In some examples, the aerosol-generating device may heat the aerosol-forming substrate to facilitate release of volatile compounds from the substrate. An electrically operated aerosol-generating device may comprise an atomiser, such as an electric heater, to heat the aerosol-forming substrate to form an aerosol.

As used herein, the term ‘aerosol-generating system’ refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

As used herein, the term ‘proximal’ refers to a user-end, or mouth-end of the aerosol-generating article, and the term ‘distal’ refers to the end opposite to the proximal end.

As used herein, a ‘susceptor’ or ‘susceptor element’ means an element that heats up when subjected to an alternating magnetic field. This may be the result of eddy currents induced in the susceptor element, hysteresis losses, or both eddy currents and hysteresis losses. During use, the susceptor element is located in thermal contact or close thermal proximity with an aerosol-forming substrate received in the aerosol-generating device or cartridge. In this manner, the aerosol-forming substrate is heated by the susceptor such that an aerosol is formed.

The susceptor material may be any material that can be inductively heated to a temperature sufficient to aerosolize an aerosol-forming substrate. The following examples and features concerning the susceptor may apply to one or both of the susceptor element of the cartridge, a susceptor of an aerosol-generating device, and a susceptor of an aerosol-generating article. Suitable materials for the susceptor material include graphite, molybdenum, silicon carbide, stainless steels, niobium, aluminium, nickel, nickel containing compounds, titanium, and composites of metallic materials. Preferred susceptor materials comprise a metal or carbon. Advantageously the susceptor material may comprise or consists of a ferromagnetic or ferri-magnetic material, for example, ferritic iron, a ferromagnetic alloy, such as ferromagnetic steel or stainless steel, ferromagnetic particles, and ferrite. A suitable susceptor material may be, or comprise, aluminium. The susceptor material may comprise more than 5 percent, preferably more than 20 percent, more preferably more than 50 percent, or more than 90 percent of ferromagnetic, ferri-magnetic or paramagnetic materials. Preferred susceptor materials may be heated to a temperature in excess of 250 degrees Celsius without degradation.

### Test Method A:

Five square-shaped samples, each having a side length of 10 millimeters, are cut out from a heat-shrinkable wrapper.

The samples are conditioned at 23° C.+/−2° C. in air at 50%+/−5% relative humidity for at least 40 hours.

Then, the samples are heated in an oven for 5 minutes at 120° C.+/−2° C.

The samples are then removed from the oven and cooled down to 23° C.+/−2° C. Then, the linear dimensions of each of the five samples are recorded in both machine direction and cross-direction. From the five recorded values, an average value is determined for both the machine direction and cross-direction. The average value is determined by the sum of the five measured values in units of millimeters divided by 5.

The shrinkage rate in percent length shrinkage is calculated for each machine direction and cross-direction by dividing the respective average value by 10 millimeters and multiplication by 100.

The shrinkage rate in percent area shrinkage is calculated by multiplying the average value in machine direction by the average value in cross-direction and dividing the product by 1 square millimeter.

Below, there is provided a non-exhaustive list of non-limiting examples. Any one or more of the features of these examples may be combined with any one or more features of another example, embodiment, or aspect described herein.

Example E1: An aerosol-generating article, comprising an aerosol-forming substrate portion and a heat-shrinkable wrapper at least partly circumscribing the aerosol-forming substrate portion,
preferably wherein the heat-shrinkable wrapper has a shrinkage rate in length of 1% to 25%,
more preferably wherein the heat-shrinkable wrapper has a shrinkage rate in length of 1% to 25% at a temperature of 120 degrees Celsius or below.

Example E2: The aerosol-generating article according to Example E1, wherein the aerosol-generating article is configured as a heat-not-burn article to be used with an aerosol-generating device.

Example E3: The aerosol-generating article according to Example E1 or Example E2, wherein the heat-shrinkable wrapper at least partly circumscribes an anchoring element, and wherein the anchoring element is one or both of a filter element, a hollow tubular element, and a front plug.

Example E4: The aerosol-generating article according to any of the preceding examples, comprising a front plug arranged at a distal end of the aerosol-generating article, preferably, wherein the front plug is configured as an anchoring element and the heat-shrinkable wrapper at least partly circumscribes the front plug.

Example E5: The aerosol-generating article according to Example E4, wherein the front plug comprises a filter material.

Example E6: The aerosol-generating article according to Example E4 or Example E5, wherein a length of the front plug is 4 millimeters or greater, preferably 5 millimeters or greater, more preferably 6 millimeters or greater.

Example E7: The aerosol-generating article according to any of Examples E4 to E6, wherein a ratio of a length of the front plug to a length of the aerosol-forming substrate portion is 0.3 or greater, preferably 0.4 or greater, more preferably 0.5 or greater.

Example E8: The aerosol-generating article according to any of the preceding examples, wherein a length of the aerosol-forming substrate portion is between 9 millimeters and 15 millimeters, preferably between 11 millimeters and 13 millimeters, more preferably about 12 millimeters.

Example E9: The aerosol-generating article according to any of the preceding examples, wherein a density of the aerosol-forming substrate portion is between 0.3 gram per cubic centimeter and 1 gram per cubic centimeter, preferably between 0.4 gram per cubic centimeter and 0.9 gram per cubic centimeter.

Example E10: The aerosol-generating article according to any of the preceding examples, comprising a susceptor element.

Example E11: The aerosol-generating article according to Example E10, wherein the susceptor element is circumscribed by the aerosol-forming substrate portion.

Example E12: The aerosol-generating article according to any of the preceding examples, wherein the aerosol-forming substrate portion comprises an aerosol former, preferably wherein the aerosol former is selected from one or more of polyhydric alcohols, esters of polyhydric alcohols, and aliphatic esters of mono-, di- or polycarboxylic acids, more preferably, wherein the aerosol former comprises polyhydric alcohols or mixtures thereof, more preferably wherein the aerosol former comprises glycerine.

Example E13: The aerosol-generating article according to Example E12, wherein the aerosol-forming substrate portion comprises an aerosol former content of equal to or greater than 5 percent by weight on a dry weight basis, preferably from 5 percent to 30 percent by weight on a dry weight basis.

Example E14: The aerosol-generating article according to any of the preceding examples, wherein the heat-shrinkable wrapper has a shrinkage rate of 1% to 9%, preferably 2% to 8%, more preferably 3% to 7%, or a shrinkage rate of 1% to 25%, preferably 2% to 20%, more preferably 3% to 15%,
wherein the shrinkage rate is measured in analogy to ISO 11501 “Determination of dimensional change on heating” with film specimens sized 5×10 cm cut from the heat-shrinkable wrapper and placed in an oven in air, for 5 minutes at 120° C., and wherein the relative decrease in length of the so treated film compared to the original film is reported as percent shrinkage.

Example E15: The aerosol-generating article according to any of the preceding examples, wherein the heat-shrinkable wrapper has a shrinkage rate in length of 1% to 25%, preferably 2% to 20%, more preferably 3% to 15%, in one or both of machine direction and cross-direction, wherein the shrinkage rate is measured in percent length shrinkage according to Test Method A as defined in the description.

Example E16: The aerosol-generating article according to Example E15, wherein the shrinkage rate in length in machine direction exceeds the shrinkage rate in length in cross-direction, and wherein the cross-direction of the heat-shrinkable wrapper is oriented in parallel to a longitudinal axis of the aerosol-generating article.

Example E17: The aerosol-generating article according to Example E15, wherein the shrinkage rate in length in cross-direction exceeds the shrinkage rate in length in machine direction, and wherein the machine direction of the heat-shrinkable wrapper is oriented in parallel to a longitudinal axis of the aerosol-generating article.

Example E18: The aerosol-generating article according to any of the preceding examples, wherein the heat-shrinkable wrapper has a shrinkage rate in area of 2% to 50%, preferably 4% to 40%, more preferably 6% to 30%, wherein the shrinkage rate is measured in percent area shrinkage according to Test Method A as defined in the description.

Example E19: The aerosol-generating article according to any of the preceding examples, wherein the heat-shrinkable wrapper comprises one or more of cellophane, cellulose hydrate, methylcellulose, carboxymethylcellulose, biaxial orientated poly propylene (BOPP), and low density polyethylene (LDPE).

Example E20: The aerosol-generating article according to Example E19, wherein the heat-shrinkable wrapper comprises a cellulose derivative, preferably one or more of cellulose hydrate, methylcellulose, and carboxymethylcellulose.

Example E21: The aerosol-generating article according to Example E20, wherein the heat-shrinkable wrapper comprises cellulose hydrate or cellophane.

Example E22: The aerosol-generating article according to Example E21, wherein the cellulose hydrate or cellophane, is coated with polyvinylidene chloride (PVDC).

Example E23: The aerosol-generating article according to Example E19, wherein the heat-shrinkable wrapper comprises biaxial orientated poly propylene (BOPP).

Example E24: The aerosol-generating article according to any of Examples E1 to E19, wherein the heat-shrinkable wrapper comprises a solid aerosol-forming substrate.

Example E25: The aerosol-generating article according to Example E24, wherein the solid aerosol-forming substrate comprises nicotine, one or more cellulose based agents, one or more aerosol formers, and one or more carboxylic acids that: (i) do not contain any non-carboxyl alkyl hydroxyl groups and do not contain any ketone groups; or (ii) have a pKa at 25° C. in water of less than or equal to 3.5; or (iii) do not contain any non-carboxyl alkyl hydroxyl groups, do not contain any ketone groups, and have a pKa at 25° C. in water of less than or equal to 3.5, and
wherein the solid aerosol-forming substrate has a total cellulose based agent content of at least 35 percent by weight, a total aerosol former content of greater than or equal to 45 percent by weight, and a total carboxylic acid content of at least 0.5 percent by weight.

Example E26: The aerosol-generating article according to Example E24 or Example E25, wherein the solid aerosol-forming substrate comprises one or more carboxylic acids selected from acetic acid, adipic acid, benzoic acid, citric acid, fumaric acid, maleic acid, malic acid, myristic acid, oxalic acid, salicylic acid, stearic acid, succinic acid, and undecanoic acid.

Example E27: The aerosol-generating article according to any of Examples E24 to E26, wherein the solid aerosol-forming substrate comprises one or more carboxylic acids selected from acetic acid, adipic acid, benzoic acid, citric acid, fumaric acid, maleic acid, myristic acid, oxalic acid, salicylic acid, stearic acid, succinic acid, and undecanoic acid.

Example E28: The aerosol-generating article according to Example E27, wherein the solid aerosol-forming substrate comprises one or more carboxylic acids selected from acetic acid, benzoic acid, citric acid, fumaric acid, maleic acid, and malic acid.

Example E29: The aerosol-generating article according to Example E28, wherein the solid aerosol-forming substrate comprises one or more carboxylic acids selected from acetic acid, benzoic acid, citric acid, fumaric acid, and maleic acid.

Example E30: The aerosol-generating article according to Example E29, wherein the solid aerosol-forming substrate comprises one or more carboxylic acids selected from fumaric acid, maleic acid, and malic acid.

Example E31: The aerosol-generating article according to Example E30, wherein the solid aerosol-forming substrate comprises one or more carboxylic acids selected from fumaric acid and maleic acid.

Example E32: The aerosol-generating article according to Example E31, wherein the solid aerosol-forming substrate comprises fumaric acid.

Example E33: The aerosol-generating article according to Example E32, wherein the molar ratio of fumaric acid to nicotine in the solid aerosol-forming substrate is between 0.5:1 and 4:1.

Example E34: The aerosol-generating article according to any of Examples E24 to E33, wherein the solid aerosol-forming substrate does not comprise iota-carrageenan or kappa-carrageenan.

Example E35: The aerosol-generating article according to any of Examples E24 to E34, wherein the solid aerosol-forming substrate further comprises one or more carboxylic acids selected from lactic acid and levulinic acid.

Example E36: The aerosol-generating article according to any of Examples E24 to E35, wherein the solid aerosol-forming substrate has a total carboxylic acid content of between 1 percent and 6 percent by weight.

Example E37: The aerosol-generating article according to any of Examples E24 to E36, wherein the molar ratio of total carboxylic acid to nicotine in the solid aerosol-forming substrate is between 0.5:1 and 5:1.

Example E38: The aerosol-generating article according to any of Examples E24 to E37, wherein the solid aerosol-forming substrate has a total cellulose based agent content of between 35 percent by weight and 50 percent by weight.

Example E39: The aerosol-generating article according to any of Examples E24 to E38, wherein the solid aerosol-forming substrate comprises one or more cellulose based film-forming agents selected from carboxymethyl cellulose and hydroxypropyl methylcellulose.

Example E40: The aerosol-generating article according to any of Examples E24 to E39, wherein the solid aerosol-forming substrate comprises one or more cellulose based strengthening agents selected from cellulose fibres, microcrystalline cellulose and cellulose powder.

Example E41: The aerosol-generating article according to any of Examples E24 to E40, wherein the aerosol-generating article comprises a susceptor, and wherein the solid aerosol-forming substrate at least partially surrounds the susceptor.

Example E42: The aerosol-generating article according to any of Examples E24 to E41, wherein the solid aerosol-forming substrate is a solid aerosol-forming film.

Example E43: The aerosol-generating article according to any of Examples E24 to E42, wherein the solid aerosol-forming film remains solid when heated to a temperature of between 180 degrees Celsius and 350 degrees Celsius.

Example E44: The aerosol-generating article according to any of Examples E1 to E19,
wherein the aerosol-forming substrate portion comprises a primary aerosol-forming substrate, wherein the heat-shrinkable wrapper comprises a secondary aerosol-forming substrate, and
wherein one or both of the primary and secondary aerosol-forming substrates comprise one or more cellulose based agents, one or more aerosol formers, and one or more carboxylic acids,
preferably wherein one or both of the primary and secondary aerosol-forming substrates comprise nicotine, one or more cellulose based agents, one or more aerosol formers, and one or more carboxylic acids.

Example E45: The aerosol-generating article according to Example E44, wherein the secondary aerosol-forming substrate comprises one or more cellulose based agents, one or more aerosol formers, and one or more carboxylic acids.

Example E46: The aerosol-generating article according to Example E44 or Example E45, wherein the primary aerosol-forming substrate comprises a tobacco material.

Example E47: The aerosol-generating article according to any of Examples E44 to E46, wherein one or both of the primary and secondary aerosol-forming substrates comprise a total nicotine content on a dry weight basis of between 0.1 percent by weight and 6 percent by weight, more preferably between 0.5 percent by weight and 4 percent by weight, more preferably between 1.0 percent by weight and 2.0 percent by weight, more preferably between 1.2 percent by weight and 1.8 percent by weight.

Example E48: The aerosol-generating article according to any of Examples E44 to E47, wherein one or both of the primary and secondary aerosol-forming substrates comprise a total aerosol former content on a dry weight basis of at least 30 percent by weight, more preferably at least 35 percent by weight, more preferably at least 40 percent by weight, more preferably at least 45 percent by weight, more preferably at least 50 percent by weight.

Example E49: The aerosol-generating article according to any of Examples E44 to E48, wherein the aerosol former comprises glycerin.

Example E50: The aerosol-generating article according to any of Examples E44 to E49, wherein one or both of the primary and secondary aerosol-forming substrates comprise a total carboxylic acid content on a dry weight basis of between 0.1 percent by weight and 6 percent by weight, preferably between 0.5 percent by weight and 4 percent by weight, more preferably between 1.0 percent by weight and 2.5 percent by weight, more preferably between 1.4 percent by weight and 2.0 percent by weight.

Example E51: The aerosol-generating article according to any of Examples E44 to E50, wherein the one or more carboxylic acids:
(i) do not contain any non-carboxyl alkyl hydroxyl groups and do not contain any ketone groups; or
(ii) have a pKa at 25° C. in water of less than or equal to 3.5; or
(iii) do not contain any non-carboxyl alkyl hydroxyl groups, do not contain any ketone groups, and have a pKa at 25° C. in water of less than or equal to 3.5.

Example E52: The aerosol-generating article according to any of Examples E44 to E51, wherein the one or more carboxylic acids are selected from lactic acid, levulinic acid, acetic acid, adipic acid, benzoic acid, citric acid, fumaric acid, maleic acid, malic acid, myristic acid, oxalic acid, salicylic acid, stearic acid, succinic acid, and undecanoic acid,
preferably wherein the one or more carboxylic acids are selected from acetic acid, adipic acid, benzoic acid, citric acid, fumaric acid, maleic acid, malic acid, myristic acid, oxalic acid, salicylic acid, stearic acid, succinic acid, and undecanoic acid,
more preferably wherein the one or more carboxylic acids are selected from acetic acid, benzoic acid, citric acid, fumaric acid, maleic acid, and malic acid.

Example E53: The aerosol-generating article according to Example E52, wherein the one or more carboxylic acids are selected from fumaric acid, maleic acid, and malic acid, preferably wherein the one or more carboxylic acids are selected from fumaric acid and maleic acid, more preferably wherein the one or more carboxylic acids is fumaric acid.

Example E54: The aerosol-generating article according to any of Examples E44 to E53, wherein one or both of the primary and secondary aerosol-forming substrates comprise fumaric acid.

Example E55: The aerosol-generating article according to any of Examples E44 to E54, wherein one or both of the primary and secondary aerosol-forming substrates comprise a total tobacco content on a dry weight basis of less than 5 percent by weight, preferably less than 4 percent by weight, more preferably less than 3 percent by weight, more preferably less than 2 percent by weight, more preferably less than 1 percent by weight, more preferably wherein one or both of the primary and secondary aerosol-forming substrates are tobacco-free.

Example E56: The aerosol-generating article according to any of Examples E44 to E55, wherein one or both of the primary and secondary aerosol-forming substrates have a total cellulose based agent content on a dry weight basis of between 35 percent by weight and 55 percent by weight, preferably between 40 percent by weight and 50 percent by weight, more preferably between 43 percent by weight and 47 percent by weight.

Example E57: The aerosol-generating article according to any of Examples E44 to E56, wherein the cellulose based agent comprises one or more cellulose based film-forming agents selected from carboxymethyl cellulose and hydroxypropyl methylcellulose.

Example E58: The aerosol-generating article according to any of Examples E44 to E57, wherein the cellulose based agent comprises one or more cellulose based strengthening agents selected from cellulose fibers, microcrystalline cellulose and cellulose powder.

Example E59: The aerosol-generating article according to any of Examples E44 to E58, wherein the cellulose based agent comprises one or more of paper, wood, textile, natural fibers, and artificial fibers.

Example E60: The aerosol-generating article according to any of Examples E44 to E59, wherein the secondary aerosol-forming substrate comprises one or more cellulose based film-forming agents selected from carboxymethyl cellulose and hydroxypropyl methylcellulose,
preferably wherein the secondary aerosol-forming substrate comprises one or more cellulose based film-forming agents selected from carboxymethyl cellulose and hydroxypropyl methylcellulose and one or more cellulose based strengthening agents selected from cellulose fibers, microcrystalline cellulose and cellulose powder.

Example E61: The aerosol-generating article according to Example E60, wherein the secondary aerosol-forming substrate comprises hydroxypropyl methylcellulose, sodium salt of carboxymethyl cellulose, and cellulose fibers.

Example E62: The aerosol-generating article according to Example E61, wherein the secondary aerosol-forming substrate comprises on a dry weight basis between 20 percent by weight and 25 percent by weight of hydroxypropyl methylcellulose, between 4 percent by weight and 7 percent by weight of sodium salt of carboxymethyl cellulose, and between 14 percent by weight and 20 percent by weight of cellulose fibers.

Example E63: The aerosol-generating article according to any of Examples E44 to E62, wherein one or both of the primary and secondary aerosol-forming substrates comprise nicotine and fumaric acid, preferably wherein a molar ratio of fumaric acid to nicotine is between 1.2 to 1 and 1.8 to 1, more preferably between 1.3 to 1 and 1.7 to 1, more preferably is between 1.4 to 1 and 1.6 to 1; more preferably is about 1.5 to 1.

Example E64: The aerosol-generating article according to any of Examples E44 to E63, wherein one or both of the primary and secondary aerosol-forming substrates are provided in form of a film or gel.

Example E65: The aerosol-generating article according to any of Examples E44 to E64, wherein one or both of the primary and secondary aerosol-forming substrates are provided in form of a solid aerosol-forming film, preferably wherein the solid aerosol-forming film remains solid when heated to a temperature of between 180 degrees Celsius and 350 degrees Celsius.

Example E66: The aerosol-generating article according to any of Examples E44 to E65, wherein the primary and secondary aerosol-forming substrates have the same composition, or wherein the primary and secondary aerosol-forming substrates have different compositions.

Example E67: The aerosol-generating article according to any of Examples E44 to E66, wherein the heat-shrinkable wrapper has a thickness of 60 micrometers or more, preferably 100 micrometers or more, more preferably 120 micrometers or more, more preferably 150 micrometers or more, more preferably 160 micrometers or more, more preferably 170 micrometers or more, more preferably 180 micrometers or more, more preferably 190 micrometers or more, more preferably 200 micrometers or more, or
wherein the heat-shrinkable wrapper has a thickness of between 160 micrometers and 240 micrometers, preferably between 180 micrometers and 220 micrometers.

Example E68: The aerosol-generating article according to any of Examples E44 to E67, wherein the heat-shrinkable wrapper extends along the entire length of the aerosol-forming substrate portion, preferably wherein the heat-shrinkable wrapper does not extend beyond longitudinal ends of the aerosol-forming substrate portion.

Example E69: The aerosol-generating article according to any of Examples E44 to E68, wherein the heat-shrinkable wrapper has a single layer structure.

Example E70: The aerosol-generating article according to any of Examples E44 to E69, wherein the heat-shrinkable wrapper consists of the secondary aerosol-forming substrate.

Example E71: The aerosol-generating article according to Example E69 or Example E70, wherein the heat-shrinkable wrapper is an isotropic material.

Example E72: The aerosol-generating article according to any of Examples E44 to E68, wherein the heat-shrinkable wrapper has a multi-layer structure, and wherein one of the layers of the multi-layer structure comprises the secondary aerosol-forming substrate, preferably, wherein the innermost layer facing the aerosol-forming substrate portion comprises the secondary aerosol-forming substrate.

Example E73: The aerosol-generating article according to Example E72, wherein the multi-layer structure is a dual layer structure.

Example E74: The aerosol-generating article according to Example E72 or Example E73, wherein the multi-layer structure comprises a layer of paper, cardboard, plastics, or metal foil, preferably wherein the multi-layer structure comprises an aluminium layer.

Example E75: An aerosol-generating system comprising the aerosol-generating article according to any of the preceding examples and an aerosol-generating device comprising a heating chamber configured for at least partly inserting the aerosol-generating article into the heating chamber.

Example E76: The aerosol-generating system according to Example E75, wherein the aerosol-generating device comprises an inductor coil.

Features described in relation to one embodiment may equally be applied to other embodiments of the invention.

The invention will be further described, by way of example only, with reference to the accompanying drawings in which:

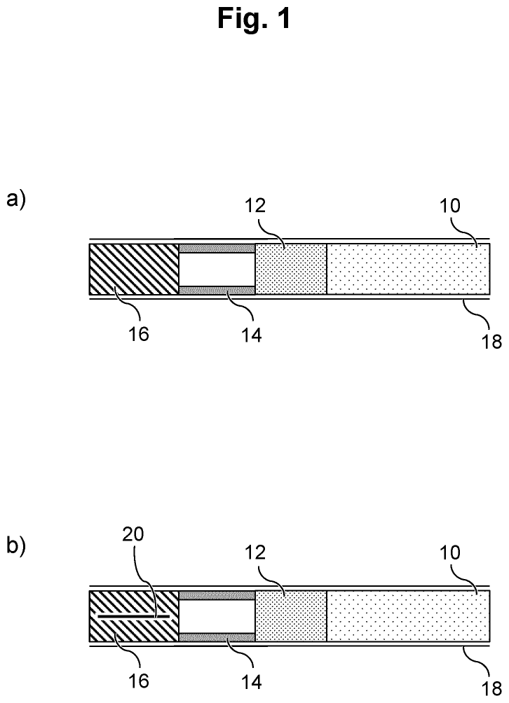

FIGS. 1a and 1b show aerosol-generating articles; and

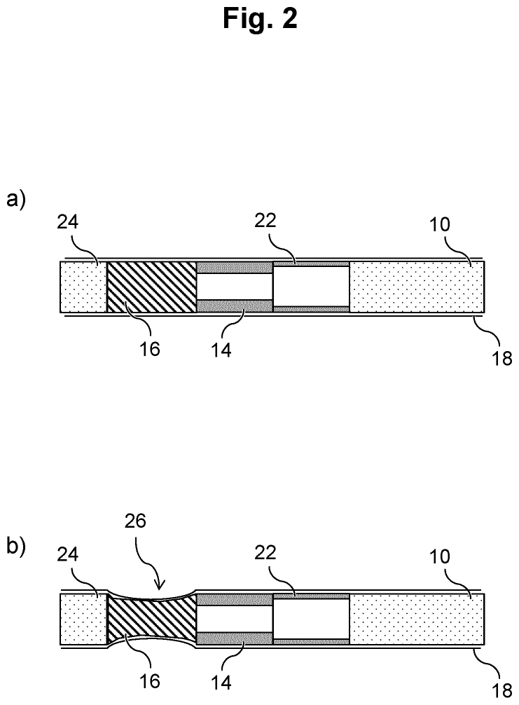

FIGS. 2a and 2b show an aerosol-generating article before and after use.

FIGS. 1a and 1b show fresh aerosol-generating articles before use, particularly HNB articles, in cross-sectional views.

The article of FIG. 1a comprises a mouth-end filter 10 located at a proximal end of the article. The article further comprises a PLA (poly lactic acid) plug 12, a hollow acetate tube 14, and an aerosol-forming substrate portion 16 comprising an aerosol-forming substrate, for example, reconstituted tobacco. The article is circumscribed by a heat-shrinkable outer wrapper 18.

An outer diameter of the article may be about 7 millimeters. A total length of the article may be about 45 millimeters. In one embodiment, a length of the mouth-end filter 14 is about 15 millimeters, a length of the PLA plug 12 is about 10 millimeters, a length of the hollow acetate tube 14 is about 8 millimeters, and a length of the aerosol-forming substrate portion 16 is about 12 millimeters. In one embodiment, a length of the mouth-end filter 14 is about 12 millimeters, a length of the PLA plug 12 is about 13 millimeters, a length of the hollow acetate tube 14 is about 8 millimeters, and a length of the aerosol-forming substrate portion 16 is about 12 millimeters.

The article of FIG. 1b is mainly identical to the article of FIG. 1a with the exception that the article of FIG. 1a comprises a sheet-like susceptor element 20 centrally arranged within the aerosol-forming substrate portion 16.

FIG. 2a shows a fresh aerosol-generating article, particularly a HNB article, in cross-sectional view before use. The article of FIG. 2a comprises a mouth-end filter 10, a fine hollow acetate tube 22, a hollow acetate tube 14, an aerosol-forming substrate portion 16, and a front plug 24. The front plug 24 may be a filter plug. The article is circumscribed by a heat-shrinkable outer wrapper 18.

An outer diameter of the article may be about 7 millimeters. A total length of the article may be about 45 millimeters. In one embodiment, a length of the mouth-end filter 10 is about 12 millimeters, a length of the fine hollow acetate tube 22 is about 8 millimeters, a length of the hollow acetate tube 14 is about 8 millimeters, a length of the aerosol-forming substrate portion 16 is about 12 millimeters, and a length of the front plug 24 is about 5 millimeters. In one embodiment, a length of the mouth-end filter 10 is about 12 millimeters, a length of the fine hollow acetate tube 22 is about 8 millimeters, a length of the hollow acetate tube 14 is about 7 millimeters, a length of the aerosol-forming substrate portion 16 is about 12 millimeters, and a length of the front plug 24 is about 6 millimeters.

The article of FIG. 2a may comprise a susceptor element (not shown) arranged within the aerosol-forming substrate portion 16.

FIG. 2b shows the aerosol-generating article of FIG. 2a after use. The spent article of FIG. 2b comprise a region 26 with a reduced outer diameter. During use, the aerosol-forming substrate portion 16 was heated. The portion of the heat-shrinkable wrapper 18 circumscribing the aerosol-forming substrate portion 16 was also heated due to thermal transfer from one or both of the heated aerosol-forming substrate portion 16 and an external heating element. Under heat exposure during use, the heat-shrinkable wrapper 18 has shrunken in the region 26 which circumscribes the aerosol-forming substrate portion 18. The contraction of the heat-shrinkable wrapper 18 caused a compression of the circumscribed aerosol-forming substrate portion 18. This results in the reduced outer diameter of the used aerosol-generating article in the region 26.

The front plug 24 and the hollow acetate tube 14 serve as anchoring elements for the heat-shrinkable wrapper 18.

From the reduced diameter in FIG. 2b, a user may visually verify whether a given article is a fresh article as shown in FIG. 2a, or a spent article as shown in FIG. 2b. It may thus be avoided that a user mistakes a spent article for a fresh article and tries to reuse a spent article.

1.-15. (canceled)

16. An aerosol-generating article, comprising:
an aerosol-forming substrate portion; and
a heat-shrinkable wrapper at least partly circumscribing the aerosol-forming substrate portion,
wherein the heat-shrinkable wrapper has a shrinkage rate in length of 1% to 25% at a temperature of 120 degrees Celsius or below, and
wherein the aerosol-generating article is configured as a heat-not-burn article for use with an aerosol-generating device.

17. The aerosol-generating article according to claim 16,
wherein the heat-shrinkable wrapper at least partly circumscribes an anchoring element, and
wherein the anchoring element is one or more of a filter element, a hollow tubular element, and a front plug.

18. The aerosol-generating article according to claim 16, further comprising a front plug arranged at a distal end of the aerosol-generating article.

19. The aerosol-generating article according to claim 18, wherein the front plug is configured as an anchoring element and the heat-shrinkable wrapper at least partly circumscribes the front plug.

20. The aerosol-generating article according to claim 18, wherein a length of the front plug is 4 millimeters or greater.

21. The aerosol-generating article according to claim 16, wherein a length of the aerosol-forming substrate portion is between 9 millimeters and 15 millimeters.

22. The aerosol-generating article according to claim 16, further comprising a susceptor element.

23. The aerosol-generating article according to claim 22, wherein the susceptor element is circumscribed by the aerosol-forming substrate portion.

24. The aerosol-generating article according to claim 16, wherein the aerosol-forming substrate portion comprises an aerosol former.

25. The aerosol-generating article according to claim 24, wherein the aerosol former is selected from one or more of polyhydric alcohols, esters of polyhydric alcohols, and aliphatic esters of mono-, di- or polycarboxylic acids.

26. The aerosol-generating article according to claim 24, wherein the aerosol former comprises polyhydric alcohols or mixtures thereof.

27. The aerosol-generating article according to claim 24, wherein the aerosol former comprises glycerine.

28. The aerosol-generating article according to claim 24, wherein the aerosol-forming substrate portion comprises an aerosol former content of equal to or greater than 5 percent by weight on a dry weight basis.

29. The aerosol-generating article according to claim 16,
wherein the heat-shrinkable wrapper has a shrinkage rate in length of 1% to 25% in one or both of machine direction and cross-direction, and
wherein the shrinkage rate is measured in percent length shrinkage according to Test Method A as defined in the description.

30. The aerosol-generating article according to claim 16, wherein the heat-shrinkable wrapper has a shrinkage rate in length of 3% to 15% in one or both of machine direction and cross-direction.

31. The aerosol-generating article according to claim 29,
wherein the shrinkage rate in length in machine direction of the heat-shrinkable wrapper exceeds the shrinkage rate in length in cross-direction of the heat-shrinkable wrapper, and
wherein the cross-direction of the heat-shrinkable wrapper is oriented in parallel to a longitudinal axis of the aerosol-generating article.

32. The aerosol-generating article according to claim 16, wherein the heat-shrinkable wrapper comprises one or more of cellophane, cellulose hydrate, methylcellulose, carboxymethylcellulose, biaxial orientated poly propylene (BOPP), and low density polyethylene (LDPE).

33. The aerosol-generating article according to claim 16, wherein the heat-shrinkable wrapper comprises cellulose hydrate or cellophane.

34. The aerosol-generating article according to claim 16, wherein the heat-shrinkable wrapper comprises biaxial orientated poly propylene (BOPP).

35. An aerosol-generating system comprising the aerosol-generating article according to claim 16 and an aerosol-generating device comprising a heating chamber configured for at least partly inserting the aerosol-generating article into the heating chamber.
